(19) United States
(12) Patent Application Publication
(10) Pub. No.: US 2018/0129285 A1
(43) Pub. Date: May 10, 2018

(54) CONTROL METHOD AND EQUIPMENT

(71) Applicant: Beijing Zhigu Rui Tuo Tech Co., Ltd, Beijing (CN)

(72) Inventor: Hao LIU, Beijing (CN)

(21) Appl. No.: 15/570,313

(22) PCT Filed: Apr. 29, 2016
(86) PCT No.: PCT/CN2016/080611

§ 371 Date: Oct. 27, 2017

(30) Foreign Application Priority Data
Apr. 30, 2015 (CN) 201510218063.9

(51) Int. Cl. G06F 3/01

(52) U.S. Cl. CPC G06F 3/015; G06F 3/017; G06F 3/013; G06F 3/012

(57) ABSTRACT

Electronic equipment and methods are described that can control or enable control. A method comprises: acquiring, in response to a head movement executed by a user, electromyographic information of an ocular region of the user; and executing an operation corresponding to the head movement according to the electromyographic information and at least one piece of reference information. For instance, a control method for executing a corresponding operation according to electromyographic information is provided. Optionally, a maximum value of amplitude of the electromyographic information captured by using the method and the equipment can reach 2 mV, thereby facilitating improvement of control precision.

### RELATED APPLICATION

The present international patent cooperative treaty (PCT) application claims the benefit of priority to Chinese Patent Application No. 201510218063.9, filed on Apr. 30, 2015, and entitled “Control Method and Equipment”, which application is hereby incorporated into the present international PCT application by reference herein in its entirety.

### TECHNICAL FIELD

The present application relates to the field of electronic equipment, and, for example, to a control method and equipment.

### BACKGROUND

At present, new technologies such as wearable computing, moving computing, and pervasive computing are developing rapidly, which raises new challenges and higher requirements for human-machine interaction technologies and also provides many new opportunities. In this stage, natural and harmonious human-machine interaction methods have been developed for a certain degree, with a major feature of performing multi-channel interaction based on input means such as gestures, voices, handwriting, or tracking, and expressions, and with the objective of enabling an individual to be capable of performing an interactive operation in a natural method such as a movement, a sound, and an expression, where an ideal “user freedom” that is emphasized in the human-machine interaction exactly lies in.

By conventional head movement-based control methods, in some cases, an electromyographic transducer is provided at a neck portion of a user, and when the user wants to turn head around, muscles at the neck portion of the user drive a head portion of the user to execute the head-turning movement. At this time, a corresponding electromyographic signal is detected, and control of electronic equipment can be implemented based on the electromyographic signal.

A maximum amplitude value of the electromyographic signal obtained by using the aforementioned control methods is approximately 0.5 mV, thereby causing a large detection error and a poor control precision.

### SUMMARY

An example objective of the present application is: to provide a control method and equipment, so as to improve control precision.

An aspect of at least one example embodiment of the present application provides a control method, comprising:

acquiring, in response to a head movement executed by a user, electromyographic information of an ocular region of the user; and

executing an operation corresponding to the head movement according to the electromyographic information and at least one piece of reference information.

An aspect of at least one example embodiment of the present application provides control equipment, comprising:

an acquiring module, configured to acquire, in response to a head movement executed by a user, electromyographic information of an ocular region of the user; and

an executing module, configured to execute an operation corresponding to the head movement according to the electromyographic information and at least one piece of reference information.

By the methods and the equipment of the example embodiments of the present application, in response to a head movement executed by a user, electromyographic information of an ocular region of the user is acquired, and an operation corresponding to the head movement is executed according to the electromyographic information and at least one piece of reference information. Therefore, a control method for executing a corresponding operation according to electromyographic information of an ocular region is provided, wherein a highest amplitude value of the electromyographic information is higher than 2 mV, and easy to detect, thereby improving control precision; and for some equipment integrated with an electromyographic transducer, for example, a smart glass, the electromyographic information captured by the electromyographic transducer can be multiplexed by using the method, thereby reducing implementation costs.

### BRIEF DESCRIPTION OF THE DRAWINGS

FIG. 1 is a flowchart of a control method of an example embodiment of the present application;

FIG. 2 is a schematic waveform diagram of electromyographic information corresponding to a shaking head movement in an example embodiment of the present application;

FIG. 3 is a schematic waveform diagram of electromyographic information corresponding to a nodding head movement in an example embodiment of the present application;

FIG. 4 is a module chart of the control equipment in another example embodiment of the present application;

FIG. 5 is a module chart of the executing module in an example embodiment of the present application;

FIG. 6 is a module chart of the determining sub-module in an example embodiment of the present application;

FIG. 7 is a module chart of the type determining unit in an example embodiment of the present application;

FIG. 8 is a module chart of the type determining unit in another example embodiment of the present application;

FIG. 9 is a module chart of the determining sub-module in another example embodiment of the present application;

FIG. 10 is a module chart of the number of times determining unit in an example embodiment of the present application;

FIG. 11 is a module chart of the number of times determining unit in another example embodiment of the present application; and

FIG. 12 is a schematic diagram of a hardware structure of the control equipment in an example embodiment of the present application.

### DETAILED DESCRIPTION

Example embodiments of the present application are described in further detail below with reference to the accompanying drawings and embodiments. The following embodiments are intended to describe the present application, but not to limit the scope of the present application.

It should be understood by a person skilled in the art that in various embodiments of the present application, the value of the serial number of each step described above does not mean an execution sequence, and the execution sequence of each step should be determined according to the function and internal logic thereof, and should not be any limitation on the implementation procedure of the example embodiments of the present application.

FIG. 1 is a flowchart of the control method of an embodiment of the present application. The method can be implemented on control equipment, for example. As shown in FIG. 1, the method comprises:

S120: Acquire, in response to a head movement executed by a user, electromyographic information of an ocular region of the user.

S140: Execute an operation corresponding to the head movement according to the electromyographic information and at least one piece of reference information.

By the method of the embodiment of the present application, in response to a head movement executed by a user, electromyographic information of an ocular region of the user is acquired, and an operation corresponding to the head movement is executed according to the electromyographic information and at least one piece of reference information. Thus, a control method for executing a corresponding operation according to electromyographic information of an ocular region is provided. A maximum value of amplitude of the electromyographic information captured by using the method can reach 2 mV, thereby facilitating improvement of control precision.

Functions of step S120 and step S140 are described in detail below with reference to example embodiments.

S120: Acquire, in response to a head movement executed by a user, electromyographic information of an ocular region of the user.

The head movement is a movement performed by a head portion of the user, for example, nodding head and shaking head. The electromyographic information may be left-eye electromyographic information or right-eye electromyographic information of the user. By using left-eye electromyographic information as an example, the left-eye electromyographic information may be captured and acquired from orbicularis oculi muscles of a left eye. The orbicularis oculi muscles are annular muscles around a bulbus oculi in tissues of an eyelid. The voluntarily or involuntarily strong contractions enable an individual to involuntarily or voluntarily blink. Specifically, the electromyographic information may be captured and acquired from an electromyographic transducer on a smart glass, for example.

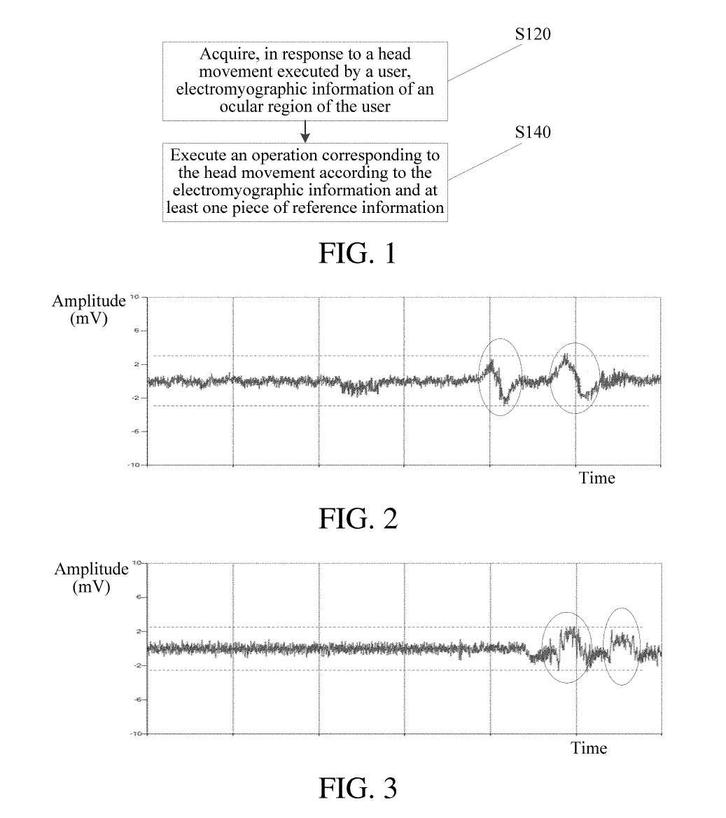

FIG. 2 is a waveform diagram of the electromyographic information of the ocular region captured by executing a shaking head movement by the user. The waveforms in the ellipses are electromyographic waveforms corresponding to the shaking head movement of the user, and the waveforms outside the ellipses are electromyographic waveforms when the user does not execute any head movement. It can be known that, when the user executes the shaking head movement, an electromyographic amplitude value of the ocular region is caused to increase obviously, with a maximum value exceeding 2 mV.

The inventor has found in the research process that: for an electromyographic signal of an ocular region, for example, an electromyographic signal of orbicularis oculi muscles, major energy is majorly centralized in a range of 50 Hz to 150 Hz, and an average amplitude value is approximately 0.5 mV; when a user performs a head movement, for example, nodding head, a relative motion between an electromyographic capturing electrode and skin and motions of other muscles on a face and ocular regions cause that an oculi electromyographic signal in a range of 0 Hz to 5 Hz with an average amplitude value of approximately 1.5 mV and a maximum amplitude value exceeding 2 mV that has an obvious waveform is introduced in the oculi electromyographic signal of the orbicularis oculi muscles. That is, the amplitude value of myoelectricity at the ocular region caused by the head movement is obviously greater than the amplitude value of myoelectricity at the neck portion caused by the head movement. Thus, the oculi electromyographic signal is utilized for controlling to execute a corresponding operation in the present application.

In addition, the inventor has also found that: when the user executes different head movements, there is an obvious difference in the obtained waveforms of the electromyographic information of the ocular region. FIG. 3 is a waveform diagram of the electromyographic information of the ocular region captured by executing a nodding head movement by the user. The waveforms in the ellipses are electromyographic waveforms corresponding to the nodding head movement of the user, and the waveforms outside the ellipses are electromyographic waveforms when the user does not execute any head movement. It can be known that, when the user executes the nodding head movement, a maximum amplitude value of myoelectricity at an ocular region may be caused to exceed 2 mV. Meanwhile, it can be known that the waveforms in the ellipses in FIG. 3 are obviously different from the waveforms in the ellipses in FIG. 2. For example, the waveforms in the ellipses in FIG. 2 change in a trend of rise first then fall, and the waveforms in the ellipses in FIG. 3 change in a trend of fall first then rise.

Similarly, other corresponding waveforms of myoelectricity at the ocular region may also be obtained when the user executes other head movements. Therefore, if it is defined that a different head movement is corresponding to a different operation, a different operation can be implemented on the electronic equipment based on the captured electromyographic information of the ocular region; and the amplitude value of the electromyographic information of the ocular region triggered by the head movement is obviously greater than an amplitude value of electromyographic information of other portions triggered by the head movement, and control precision can be improved by performing a corresponding control operation according to the electromyographic information of the ocular region.

S140: Execute an operation corresponding to the head movement according to the electromyographic information and at least one piece of reference information.

In an example embodiment, step S140 may comprise:

S141: Determine related information of the head movement according to the electromyographic information and the at least one piece of reference information.

S142: Execute the operation according to the related information.

In an example embodiment, the related information of the head movement may comprise a type of the head movement, for example, nodding head or shaking head. Correspondingly, step S141 may comprise:

S1411: Determine a type of the head movement according to the electromyographic information and the at least one piece of reference information.

In an example embodiment, step S1411 may comprise:

S14111a: Determine a target waveform in the electromyographic information.

S14112a: Determine the type of the head movement according to the target waveform and at least one reference waveform.

In step S14111a, the target waveform is a waveform, which is corresponding to the head movement, among waveforms of the electromyographic information, and is obviously different from a waveform of the electromyographic information captured when the head portion does not execute any movement.

By using the type of the head movement being a shaking head movement as an example, the obtained waveforms of the electromyographic information are shown in FIG. 2. The waveforms in the ellipses are waveforms when the head portion of the user executes a shaking head movement, and the waveforms outside the ellipses are waveforms when the head portion of the user does not execute any movement. It can be known that the waveforms in the ellipses are obviously different from the waveforms outside the ellipses in FIG. 2. Specifically, amplitude of oscillation of the waveforms in the ellipses is obviously greater than amplitude of oscillation of the waveforms outside the ellipses. On the basis of the above, the target waveform can be extracted from the electromyographic information, i.e., it can be determined that the waveforms in the ellipses are the target waveform.

Similarly, FIG. 3 illustrates waveforms of the electromyographic information obtained when the type of the head movement is nodding head. The waveforms in the ellipses are waveforms when the head portion of the user executes a nodding head movement, and the waveforms outside the ellipses are waveforms when the head portion of the user does not execute any movement. It can be known that in FIG. 3, amplitude of oscillation of the waveforms in the ellipses is also obviously greater than amplitude of oscillation of the waveforms outside the ellipses. On the basis of the above, it can be determined that the waveforms in the ellipses are the target waveform.

In step S14112a, the reference waveform may be a waveform that is obtained by pretraining and is corresponding to a corresponding head movement. For example, in a training stage, a user is asked to execute different types of head movements, separately, and corresponding waveforms are acquired accordingly and used as the reference waveforms. For example, at a training stage, a user is asked to execute a shaking head movement, and the waveforms in the ellipses in FIG. 2 are accordingly acquired as reference waveforms corresponding to the shaking head movement.

In a situation in which a quantity of the at least one reference waveform is small, that is, a few of types of the head movements are provided, whether the target waveform comprises the at least one reference waveform is determined by using a method of image identification, for example. If the target waveform comprises the at least one reference waveform, the type of the head movement is determined as a type corresponding to the comprised reference waveform. By using FIG. 2 and FIG. 3 for example, it can be known that there is an obvious difference between the target waveform in FIG. 2 and the target waveform in FIG. 3. For example, the trend of the target waveform in FIG. 2 is first rise then fall and the trend of the target waveform in FIG. 3 is first fall then rise. On the basis of the aforementioned difference, different reference waveforms corresponding to the target waveform can be determined, that is, the target waveform can be recognized.

In a situation in which the quantity of the at least one reference waveform is relatively large, a possibility of mixing different reference waveforms increases. To avoid recognition error, in an example embodiment, step S14112a may comprise:

S14112a′: Perform cross-correlation computation on the target waveform and the at least one reference waveform, separately, and determine the type of the head movement according to a computed result.

Specifically, cross-correlation computation is performed on the target waveform and the at least one reference waveform, separately, to obtain a computed result corresponding to each reference waveform, and a type corresponding to a reference waveform having a highest value in the computed result (that is, a reference waveform having a highest correlation with the target waveform) is then selected as the type of the head movement. For example, it is assumed that the at least one reference waveform comprises a first reference waveform corresponding to nodding head and a second reference waveform corresponding to shaking head, the cross-correlation computation is performed on the first reference waveform and the target waveform to obtain a first result, and the cross-correlation computation is performed on the second reference waveform and the target waveform to obtain a second result; and if a value of the first result is higher than a value of the second result, it can be determined that the type of the head movement is nodding head.

In another example embodiment, step S1411 may comprise:

S14111b: Determine a target signal characteristic in the electromyographic information.

S14112b: Determine the type of the head movement according to the target signal characteristic and at least one reference signal characteristic.

In step S14111b, the target signal characteristic may be understood as the signal characteristic of the target waveform in the previous example embodiment, and the target signal characteristic may be correlated with at least one item of amplitude, phase, and spectrum of the target waveform. Specifically, the target signal characteristic may comprise: at least one item of fingerprint, average value, and difference; the fingerprint may be composed of at least one item of the amplitude, the phase, and the spectrum of the target waveform; the average value may be an average value of at least one item of the amplitude, the phase, and the spectrum of the target waveform; and the difference may be a difference of at least one item of the amplitude, the phase, and the spectrum of the target waveform. Certainly, it should be understood by a person skilled in the art that the target signal characteristic may be directly determined according to data of the electromyographic information, not necessarily according to the target waveform.

In step S14112b, the reference signal characteristic may be a signal characteristic that is obtained by pretraining and is corresponding to a corresponding head movement. For example, in a training stage, a user is asked to execute different types of head movements, separately, and signal characteristics of the corresponding electromyographic information of an ocular region are acquired accordingly and used as the reference signal characteristics. For example, at a training stage, a user is asked to execute a shaking head movement, and the waveforms in the ellipses in FIG. 2 are accordingly acquired as reference signal characteristics corresponding to the shaking head movement.

In step S14112b, whether the target signal characteristic comprises the at least one reference signal characteristic may be determined by using a method of comparing signal characteristics, for example, and if the target signal characteristic comprises the at least one reference signal characteristic, the type of the head movement is determined as a type corresponding to the comprised reference signal characteristic.

The type of the head movement may represent a different operation command, for example, the nodding head represents confirmation and the shaking head represents canceling. Meanwhile, for a different type of head movement, to execute the different type of head movement for a different number of times may also represent a different operation command. For example, nodding head once represents selected and nodding head twice successively represents opening. Therefore, in an example embodiment, the head movement comprises a first type head movement; and the at least one piece of reference information comprises first reference information corresponding to the first type head movement.

Correspondingly, step S141 may further comprise:

S1412: Determine the number of the first type head movements according to the electromyographic information and the first reference information.

In an example embodiment, step S1412 may comprise:

S14121a: Determine a target waveform in the electromyographic information.

S14122a: Determine the number of the first type head movements according to a quantity of first reference waveforms comprised in the target waveform.

The implementation principles of step S14121a are the same as the implementation principles of step S14111a, which are not described herein again.

In step S14122a, the quantity of the first reference waveforms comprised in the target waveform is corresponding to the number of the first type head movements. It is assumed that the first type head movement is shaking head, and the first reference waveform is a reference waveform corresponding to the shaking head. By using FIG. 2 as an example, it can be known that the target waveform comprises two of such the first reference waveforms, and it can be therefore determined that the user conducts the shaking head movement twice. Similarly, the electromyographic information shown in FIG. 3 represents that the user conducts the nodding head movement twice.

In another example embodiment, step S1412 may comprise:

S14121b: Determine a target signal characteristic in the electromyographic information.

S14122b: Determine the number of the first type head movements according to a quantity of the first reference signal characteristics comprised in the target signal characteristic.

The implementation principles of step S14121b are the same as the implementation principles of step S14111b, which are not described herein again.

In step S14122b, the quantity of first reference signal characteristics comprised in the target signal characteristic is corresponding to the number of the first type head movements. It is still assumed that the first type head movement is shaking head and the first reference signal characteristic is variable data of an amplitude value corresponding to the shaking head (for example, the amplitude value first rises to exceed 2 mV and then falls below −2 mV). By using FIG. 2 as an example, it can be known that the target signal characteristic in the electromyographic information comprises two of such the first reference signal characteristics, and therefore it can be determined that the user conducts the shaking head movement twice. Certainly, it should be understood by a person skilled in the art that it is not a must to obtain the waveform curve shown in FIG. 2 in the step. Similarly, the electromyographic information shown in FIG. 3 represents that the user conducts the nodding head movement twice.

In addition, the head movement may probably comprise other types of head movements, for example, a second type head movement. Alternatively, the head movement may simultaneously comprise a plurality of types of head movements, for example, the head movement simultaneously comprises a first type head movement and a second type head movement. The number of head movements for each type can be implemented separately according to the aforementioned implementation principles.

In step S142: Execute the operation according to the related information.

The execution operation may comprise an operation, for example, switch mode, input content, prompt user, and match equipment.

For example, in a process in which a user wears a smart glass, a head movement of the user is monitored, and if the user nods head once, a current object is selected, for example, an application icon displayed currently is selected; if the user nods head twice successively, a current object is opened directly; and if the user shakes head, a next object is switched to.

In addition, it should be noted that to facilitate description of the principles of the method, step S140 in the aforementioned example embodiments essentially implements the aforementioned control method according to a first correspondence between the at least one piece of reference information and the related information of the head movement and a second correspondence between the related information and the operation.

It should be understood by a person skilled in the art that it is not a must to determine the first correspondence in step S140, because the control method can be implemented according to a third correspondence between the at least one piece of reference information and the operation only. That is, in another example embodiment, there is readily a correspondence between the at least one piece of reference information and the operation. Therefore, according to the electromyographic information and the at least one piece of reference information, the operation can be readily determined and executed. For example, it is assumed that the at least one piece of reference information comprises target reference information corresponding to a turn-off command. In a situation when a user executes a head movement to trigger electromyographic information and the electromyographic information matches the target reference information, corresponding electronic equipment can be controlled to be turned off directly.

Besides, an embodiment of the present application further provides a computer-readable medium, comprising computer-readable instructions that perform, and when being executed, the following operations: operations of executing steps S120 and S140 of the method in the example embodiment shown in FIG. 1.

In view of the above, by the methods of example embodiments of the present application, electromyographic information of an ocular region may be triggered by a head movement of a user to control to execute a corresponding operation. Because an amplitude value of the electromyographic information is large, it is beneficial for improvement of control precision; and in a situation in which some wearable equipment has the electromyographic transducer, it is convenient for the user to control corresponding electronic equipment through a head movement in a premise of not increasing implementation costs.

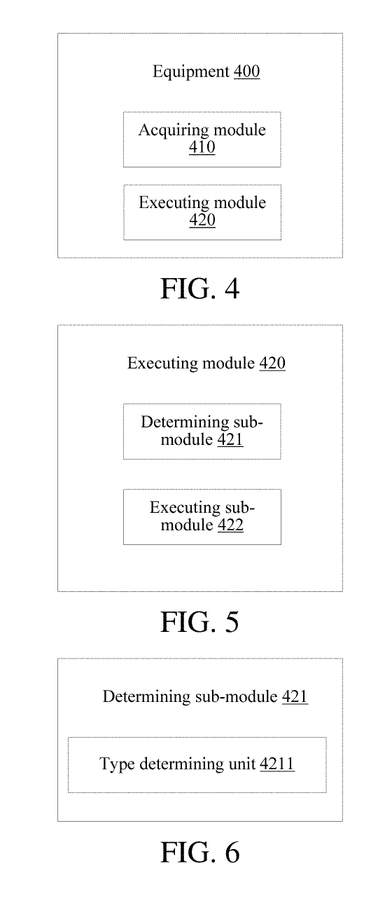

FIG. 4 is a schematic diagram of module structure of the control equipment of an embodiment of the present application. The equipment may be independent control equipment, and certainly can also be configured as a functional module to be integrated in wearable equipment such as a smart glass. Referring to FIG. 4, the equipment 400 may comprise:

an acquiring module 410, configured to acquire, in response to a head movement executed by a user, electromyographic information of an ocular region of the user; and

an executing module 420, configured to execute an operation corresponding to the head movement according to the electromyographic information and at least one piece of reference information.

By the equipment of the embodiment of the present application, in response to a head movement executed by a user, electromyographic information of an ocular region of the user is acquired, and an operation corresponding to the head movement is executed according to the electromyographic information and at least one piece of reference information. Therefore, control equipment for executing a corresponding operation according to electromyographic information of an ocular region is provided, thereby facilitating improvement of control precision; and for some equipment integrated with an electromyographic transducer, for example, a smart glass, control of the equipment or other equipment can be implemented by multiplexing the electromyographic information captured by the electromyographic transducer, thereby reducing implementation costs.

Functions of the acquiring module 410 and the executing module 420 are described in detail with reference to example embodiments below.

The acquiring module 410 is configured to acquire, in response to a head movement executed by a user, electromyographic information of an ocular region of the user.

The head movement is a movement performed by a head portion of the user, for example, nodding head and shaking head. The electromyographic information may be left-eye electromyographic information or right-eye electromyographic information of the user. Acquisition by the acquiring module 410 may be performed through an electromyographic transducer on a smart glass, for example.

The executing module 420 is configured to execute an operation corresponding to the head movement according to the electromyographic information and at least one piece of reference information.

Referring to FIG. 5, in an example embodiment, the executing module 420 may comprise:

a determining sub-module 421, configured to determine related information of the head movement according to the electromyographic information and the at least one piece of reference information; and

an executing sub-module 422, configured to execute the operation according to the related information.

In an example embodiment, the related information of the head movement may comprise a type of the head movement, for example, nodding head or shaking head. Correspondingly, referring to FIG. 6, the determining sub-module 421 may comprise:

a type determining unit 4211, configured to determine a type of the head movement according to the electromyographic information and the at least one piece of reference information.

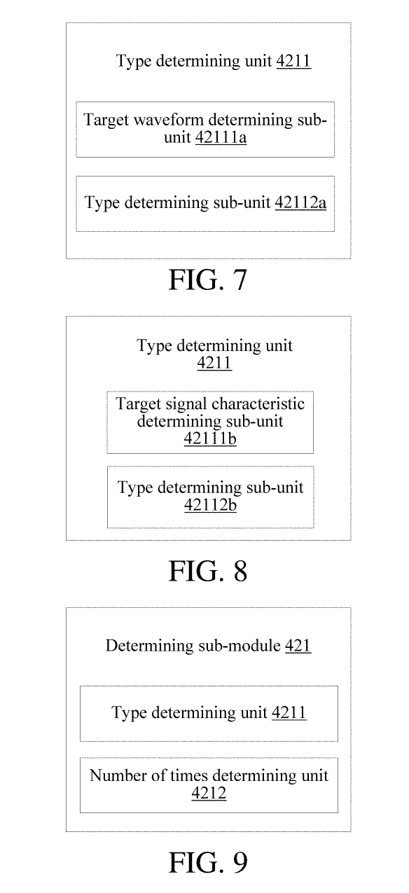

In an example embodiment, referring to FIG. 7, the type determining unit 4211 may comprise:

a target waveform determining sub-unit 42111a, configured to determine a target waveform in the electromyographic information; and

a type determining sub-unit 42112a, configured to determine a type of the head movement according to the target waveform and at least one reference waveform.

In the target waveform determining sub-unit 42111a, the target waveform is a waveform, which is corresponding to the head movement, among waveforms of the electromyographic information, and is obviously different from a waveform of the electromyographic information captured when the head portion does not execute any movement.

By using the type of the head movement being a shaking head movement as an example, the obtained waveforms of the electromyographic information are shown in FIG. 2. The waveforms in the ellipses are waveforms when the head portion of the user executes a shaking head movement, and the waveforms outside the ellipses are waveforms when the head portion of the user does not execute any movement. It can be known that the waveforms in the ellipses are obviously different from the waveforms outside the ellipses in FIG. 2. Specifically, amplitude of oscillation of the waveforms in the ellipses is obviously greater than amplitude of oscillation of the waveforms outside the ellipses. On the basis of the above, the target waveform can be extracted from the electromyographic information, i.e., it can be determined that the waveforms in the ellipses are the target waveform.

Similarly, FIG. 3 illustrates waveforms of the electromyographic information obtained when the type of the head movement is nodding head. The waveforms in the ellipses are waveforms when the head portion of the user executes a nodding head movement, and the waveforms outside the ellipses are waveforms when the head portion of the user does not execute any movement. It can be known that in FIG. 3, amplitude of oscillation of the waveforms in the ellipses is also obviously greater than amplitude of oscillation of the waveforms outside the ellipses. On the basis of the above, it can be determined that the waveforms in the ellipses are the target waveform.

In the type determining sub-unit 42112a, the reference waveform may be a waveform that is obtained by pretraining and is corresponding to a corresponding head movement. For example, in a training stage, a user is asked to execute different types of head movements, separately, and corresponding waveforms are acquired accordingly and used as the reference waveforms. For example, at a training stage, a user is asked to execute a shaking head movement, and the waveforms in the ellipses in FIG. 2 are accordingly acquired as reference waveforms corresponding to the shaking head movement.

In a situation in which a quantity of the at least one reference waveform is small, that is, a few of types of the head movements are provided, whether the target waveform comprises the at least one reference waveform is determined by using a method of image identification, for example. If the target waveform comprises the at least one reference waveform, the type of the head movement is determined as a type corresponding to the comprised reference waveform. By using FIG. 2 and FIG. 3 for example, it can be known that there is an obvious difference between the target waveform in FIG. 2 and the target waveform in FIG. 3. For example, the trend of the target waveform in FIG. 2 is first rise then fall and the trend of the target waveform in FIG. 3 is first fall then rise. On the basis of the aforementioned difference, different reference waveforms corresponding to the target waveform can be determined, that is, the target waveform can be recognized.

In a situation in which the quantity of the at least one reference waveform is relatively large, a possibility of mixing different reference waveforms increases. To avoid recognition error, in an example embodiment, the type determining sub-unit 42112a is configured to perform cross-correlation computation on the target waveform and the at least one reference waveform, separately, and determine the type of the head movement according to a computed result.

Specifically, the type determining sub-unit 42112a performs cross-correlation computation on the target waveform and the at least one reference waveform, separately, to obtain a computed result corresponding to each reference waveform, and then determines a type corresponding to a reference waveform having a highest value in the computed result (that is, a reference waveform having a highest correlation with the target waveform) as the type of the head movement. For example, it is assumed that the at least one reference waveform comprises a first reference waveform corresponding to nodding head and a second reference waveform corresponding to shaking head, the cross-correlation computation is performed on the first reference waveform and the target waveform to obtain a first result, and the cross-correlation computation is performed on the second reference waveform and the target waveform to obtain a second result; and if a value of the first result is higher than a value of the second result, it can be determined that the type of the head movement is nodding head.

In another example embodiment, referring to FIG. 8, the type determining unit 4211 may comprise:

a target signal characteristic determining sub-unit 42111b, configured to determine a target signal characteristic in the electromyographic information; and

a type determining sub-unit 42112b, configured to determine a type of the head movement according to the target signal characteristic and at least one reference signal characteristic.

In the target signal characteristic determining sub-unit 42111b, the target signal characteristic may be understood as a signal characteristic of the target waveform in the previous example embodiment, and the target signal characteristic may be correlated with at least one item of amplitude, phase, and spectrum of the target waveform. Specifically, the target signal characteristic may comprise: at least one item of fingerprint, average value, and difference; the fingerprint may be composed of at least one item of the amplitude, the phase, and the spectrum of the target waveform; the average value may be an average value of at least one item of the amplitude, the phase, and the spectrum of the target waveform; and the difference may be a difference of at least one item of the amplitude, the phase, and the spectrum of the target waveform. Certainly, it should be understood by a person skilled in the art that the target signal characteristic may be directly determined according to data of the electromyographic information, not necessarily according to the target waveform.

In the type determining sub-unit 42112b, the reference signal characteristic may be a signal characteristic that is obtained by pretraining and is corresponding to a corresponding head movement. For example, in a training stage, a user is asked to execute different types of head movements, separately, and signal characteristics of the corresponding electromyographic information are acquired accordingly and used as the reference signal characteristics. For example, at a training stage, a user is asked to execute a shaking head movement, and the waveforms in the ellipses in FIG. 2 are accordingly acquired as reference signal characteristics corresponding to the shaking head movement.

In the type determining sub-unit 42112b, whether the target signal characteristic comprises the at least one reference signal characteristic may be determined by using a method of comparing signal characteristics, for example, and if the target signal characteristic comprises the at least one reference signal characteristic, the type of the head movement is determined as a type corresponding to the comprised reference signal characteristic.

The type of the head movement may represent a different operation command, for example, the nodding head represents confirmation and the shaking head represents canceling. Meanwhile, for a different type of head movement, to execute the different type of head movement for a different number of times may also represent a different operation command. For example, nodding head once represents selected and nodding head twice successively represents opening. Therefore, in an example embodiment, the head movement comprises a first type head movement; and the at least one piece of reference information comprises first reference information corresponding to the first type head movement. Correspondingly, referring to FIG. 9, the determining sub-module 421 further comprises:

a number of times determining unit 4212, configured to determine the number of the first type head movements according to the electromyographic information and the first reference information.

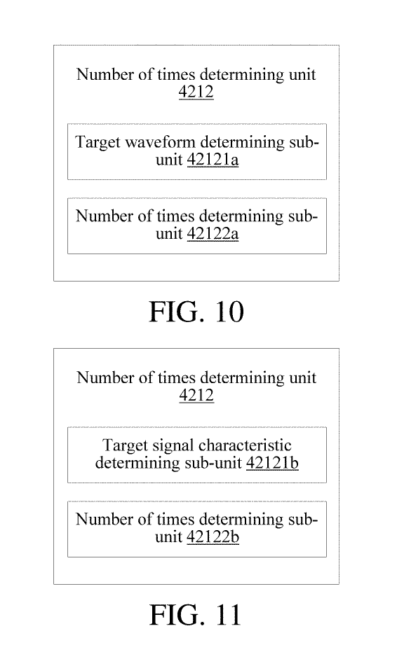

In an example embodiment, referring to FIG. 10, the number of times determining unit 4212 may comprise:

a target waveform determining sub-unit 42121a, configured to determine a target waveform in the electromyographic information; and

a number of times determining sub-unit 42122a, configured to determine the number of the first type head movements according to a quantity of first reference waveforms comprised in the target waveform.

The implementation principles of the target waveform determining sub-unit 42121a are the same as the implementation principles of the target waveform determining sub-unit 42111a, which are not described herein again.

In the number of times determining sub-unit 42122a, the quantity of the first reference waveforms comprised in the target waveform is corresponding to the number of the first type head movements. It is assumed that the first type head movement is shaking head, and the first reference waveform is a reference waveform corresponding to the shaking head. By using FIG. 2 as an example, it can be known that the target waveform comprises two of such the first reference waveforms, and it can be therefore determined that the user conducts the shaking head movement twice. Similarly, the electromyographic information shown in FIG. 3 represents that the user conducts the nodding head movement twice.

In another example embodiment, referring to FIG. 11, the number of times determining unit 4212 may comprise:

a target signal characteristic determining sub-unit 42121b, configured to determine a target signal characteristic in the electromyographic information; and

a number of times determining sub-unit 42122b, configured to determine the number of the first type head movements according to a quantity of first reference signal characteristics comprised in the target signal characteristic.

The implementation principles of the target signal characteristic determining sub-unit 42121b are the same as the implementation principles of the target signal characteristic determining sub-unit 42111b, which are not described herein again.

In the number of times determining sub-unit 42122b, the quantity of the first reference signal characteristics comprised in the target signal characteristic is corresponding to the number of the first type head movements. It is still assumed that the first type head movement is shaking head and the first reference signal characteristic is variable data of an amplitude value corresponding to the shaking head (for example, the amplitude value first rises to exceed 2 mV and then falls below −2 mV). By using FIG. 2 as an example, it can be known that the target signal characteristic in the electromyographic information comprises two of such the first reference signal characteristics, and therefore it can be determined that the user conducts the shaking head movement twice. Certainly, it should be understood by a person skilled in the art that it is not a must to obtain the waveform curve shown in FIG. 2 in the step. Similarly, the electromyographic information shown in FIG. 3 represents that the user conducts the nodding head movement twice.

In addition, the head movement may probably comprise other types of head movements, for example, a second type head movement. Alternatively, the head movement may simultaneously comprise a plurality of types of head movements, for example, the head movement simultaneously comprises a first type head movement and a second type head movement. The number of head movements for each type can be implemented separately according to the aforementioned implementation principles.

The executing sub-module 422 is configured to execute the operation according to the related information.

The execution operation may comprise an operation, for example, switch mode, input content, prompt user, and match equipment.

For example, in a process in which a user wears a smart glass, a head movement of the user is monitored, and if the user nods head once, a current object is selected, for example, an application icon displayed currently is selected; if the user nods head twice successively, a current object is opened directly; and if the user shakes head, a next object is switched to.

In view of the above, by the equipment of the embodiments of the present application, a corresponding operation is executed according to electromyographic information triggered by a head movement, and it is convenient for a user to control corresponding electronic equipment through a head movement in a premise of not increasing implementation costs.

An application scenario of the information processing method and the equipment of the embodiments of the present application may be as follows: a user wears a smart glass, the smart glass initially enters a level-one menu, and an electromyographic transducer on the smart glass acquires electromyographic information of an ocular region of the user; the user executes a shaking head movement to trigger first electromyographic information, and the smart glass controls, according to the first electromyographic information, options on the level-one menu to switch in a glass display window according to a predetermined sequence; and when an application that the user wants to open is switched to, the user executes a nodding head movement to trigger second electromyographic information, the application is selected, the user then executes the nodding head movement twice successively to trigger third electromyographic information, and the application is opened.

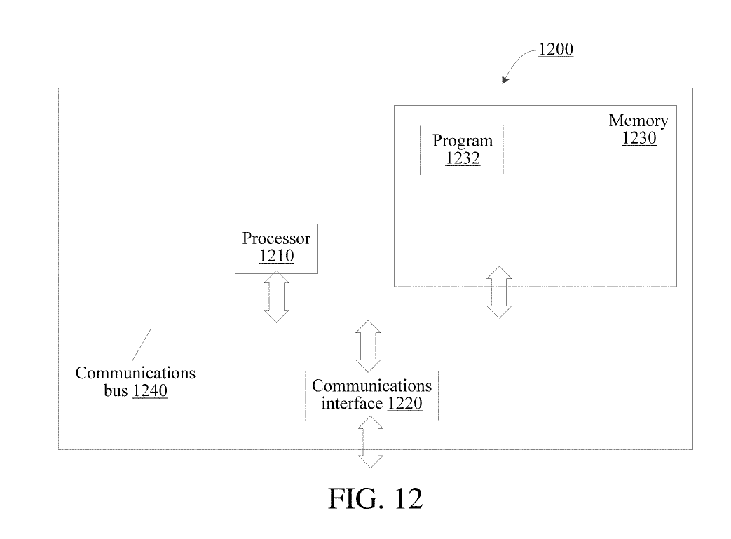

The hardware structure of the control equipment of another example embodiment of the present application is shown in FIG. 12. The specific embodiments of the present application do not specifically limit the example embodiments of the control equipment. Referring to FIG. 12, the equipment 1200 may comprise:

a processor 1210, a communications interface 1220, a memory 1230, and a communications bus 1240. Where:

The processor 1210, the communications interface 1220, and the memory 1230 communicate with each other by using the communications bus 1240.

The communications interface 1220 is configured to communicate with other network elements.

The processor 1210 is configured to execute a program 1232, and specifically can perform relevant steps in the aforementioned embodiments of the method shown in FIG. 1.

Specifically, the program 1232 may comprise a program code, where the program code comprises a computer operation instruction.

The processor 1210 may be a Central Processing Unit (CPU), an Application Specific Integrated Circuit (ASIC), or one or more integrated circuits configured to implement the embodiments of the present application.

The memory 1230 is configured to store the program 1232. The memory 1230 may comprise a high speed RAM memory, and may further comprise a non-volatile memory such as at least one magnetic disk memory. The program 1232 specifically may execute the following steps:

acquiring, in response to a head movement executed by a user, electromyographic information of an ocular region of the user; and

executing an operation corresponding to the head movement according to the electromyographic information and at least one piece of reference information.

For the example embodiment of the steps in the program 1232, refer to the corresponding descriptions of corresponding steps or modules in the aforementioned embodiments, which are not described herein again. It may be clearly understood by a person skilled in the art that, for the purpose of convenient and brief description, reference may be made to the description of corresponding processes in the aforementioned embodiments of the method for detailed working processes of the aforementioned equipment and modules, and details are not described herein again.

A person of ordinary skill in the art may be aware that, in combination with the examples described in the embodiments disclosed in this specification, units and steps of the method may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the existing art, or all or a part of the technical solutions may be implemented in the form of a software product. The software product is stored in a storage medium and comprises several instructions for instructing a computer device (which may be a personal computer, a controller, or a network device) or a processor to perform all or a part of the steps of the methods in the embodiments of the present application. The aforementioned storage medium comprises: any medium that can store a program code, such as a USB flash drive, a removable hard disk, a read-only memory (ROM), a random access memory (RAM), a magnetic disk, or an optical disc.

The above example embodiments are only used to describe the present application, rather than limit the present application; various alterations and variants can be made by those of ordinary skill in the art without departing from the spirit and scope of the present application, so all equivalent technical solutions also belong to the scope of the present application, and the scope of patent protection of the present application should be defined by claims.

What is claimed is:

1. A method, comprising:
acquiring, by a system comprising a processor, in response to a head movement executed by a user, electromyographic information of an ocular region of the user; and
executing, by the system, an operation corresponding to the head movement according to the electromyographic information and at least one piece of reference information.

2. The method of claim 1, wherein the executing the operation corresponding to the head movement according to the electromyographic information and the at least one piece of reference information comprises:
determining related information of the head movement according to the electromyographic information and the at least one piece of reference information; and
executing the operation according to the related information.

3. The method of claim 2, wherein the determining the related information of the head movement according to the electromyographic information and the at least one piece of reference information comprises:
determining a type of the head movement according to the electromyographic information and the at least one piece of reference information.

4. The method of claim 3, wherein the type of the head movement comprises: at least one item of a nodding head type or a shaking head type.

5. The method of claim 3, wherein the determining the type of the head movement according to the electromyographic information and the at least one piece of reference information comprises:
determining a target waveform in the electromyographic information; and
determining the type of the head movement according to the target waveform and at least one reference waveform.

6. The method of claim 5, wherein the determining the type of the head movement according to the target waveform and at least one reference waveform comprises:
performing cross-correlation computation on the target waveform and the at least one reference waveform, respectively, and determining the type of the head movement according to a result of the cross-correlation computation.

7. The method of claim 3, wherein the determining the type of the head movement according to the electromyographic information and the at least one piece of reference information comprises:
determining a target signal characteristic in the electromyographic information; and
determining the type of the head movement according to the target signal characteristic and at least one reference signal characteristic.

8. The method of claim 3, wherein the head movement comprises a first type head movement,
the at least one piece of reference information comprises first reference information corresponding to the first type head movement, and
the determining the related information of the head movement according to the electromyographic information and the at least one piece of reference information further comprises:
determining a number of the first type head movements according to the electromyographic information and the first reference information.

9. The method of claim 8, wherein the determining the number of the first type head movements according to the electromyographic information and the first reference information comprises:
determining a target waveform in the electromyographic information; and
determining the number of the first type head movements according to a quantity of first reference waveforms comprised in the target waveform.

10. The method of claim 8, wherein the determining the number of the first type head movements according to the electromyographic information and the first reference information comprises:
determining a target signal characteristic in the electromyographic information; and
determining the number of the first type head movements according to a quantity of first reference signal characteristics comprised in the target signal characteristic.

11. An equipment, comprising:
a memory that stores executable modules; and
a processor, coupled to the memory, that executes or facilitates execution of the executable modules, the executable modules comprising:
an acquiring module configured to acquire, in response to a head movement being determined to have been executed by a user, electromyographic information of an ocular region of the user; and
an executing module configured to execute an operation corresponding to the head movement according to the electromyographic information and a piece of reference information.

12. The equipment of claim 11, wherein the executing module comprises:
a determining sub-module configured to determine related information of the head movement according to the electromyographic information and the piece of reference information; and
an executing sub-module configured to execute the operation according to the related information.

13. The equipment of claim 12, wherein the determining sub-module comprises:
a type determining unit configured to determine a type of the head movement according to the electromyographic information and the piece of reference information.

14. The equipment of claim 13, wherein the type determining unit comprises:
a target waveform determining sub-unit configured to determine a target waveform in the electromyographic information; and
a type determining sub-unit configured to determine the type of the head movement according to the target waveform and a reference waveform.

15. The equipment of claim 14, wherein the type determining sub-unit is configured to cross-correlate the target waveform and the reference waveform, and determine the type of the head movement according to a result of the target waveform and the reference waveform being cross-correlated.

16. The equipment of claim 13, wherein the type determining unit comprises:
a target signal characteristic determining sub-unit configured to determine a target signal characteristic in the electromyographic information; and
a type determining sub-unit configured to determine the type of the head movement according to the target signal characteristic and a reference signal characteristic.

17. The equipment of claim 13, wherein the head movement comprises a first type head movement,
the piece of reference information comprises first reference information corresponding to the first type head movement, and
the determining sub-module further comprises:
a number of times determining unit, configured to determine a number of the first type head movements according to the electromyographic information and the first reference information.

18. The equipment of claim 17, wherein the number of times determining unit comprises:
a target waveform determining sub-unit configured to determine a target waveform in the electromyographic information; and
a number of times determining sub-unit configured to determine the number of the first type head movements according to a quantity of first reference waveforms comprised in the target waveform.

19. The equipment of claim 17, wherein the number of times determining unit comprises:
a target signal characteristic determining sub-unit configured to determine a target signal characteristic in the electromyographic information; and
a number of times determining sub-unit configured to determine the number of the first type head movements according to a quantity of first reference signal characteristics comprised in the target signal characteristic.

20. The equipment of claim 11, wherein the equipment is included in a wearable equipment.

21. A device, comprising at least one executable instruction, which, in response to execution, causes the device comprising a processor to perform operations, comprising:
acquiring, in response to a head movement executed by a user, electromyographic information of an ocular region of the user; and
executing an operation corresponding to the head movement according to the electromyographic information and at least one piece of reference information.

22. A device, characterized by comprising a processor and a memory, the memory storing executable instructions, the processor being connected to the memory through a communication bus, and when the device operates, the processor executing the executable instructions stored in the memory, so that the device executes operations, comprising:
in response to a head movement of a head associated with a user identity being determined to have occurred, acquiring, electromyographic information of an ocular region associated with the head; and
executing an operation corresponding to the head movement according to the electromyographic information and reference information.
